(19) United States
(12) Patent Application Publication
(10) Pub. No.: US 2013/0334193 A1
(43) Pub. Date: Dec. 19, 2013

(54) ELECTRIC HEATING DEVICE FOR VEHICLE

(71) Applicant: CALSONIC KANSEI CORPORATION, Saitama-shi (JP)

(72) Inventors: Masafumi NAGAMI, Saitama-shi (JP); Kenji Tsuneyoshi, Saitama-shi (JP)

(21) Appl. No.: 13/912,498

(22) Filed: Jun. 7, 2013

(30) Foreign Application Priority Data
Jun. 7, 2012 (JP) 2012-129544

(51) Int. Cl. H05B 1/02

(52) U.S. Cl. CPC H05B 1/0202
USPC 219/202

(57) ABSTRACT

An electric heating device for a vehicle may comprise: a switch element configured to allow an electric current to flow through an electric heater; a switch element control unit generating a switch element control signal and a switch element drive signal; and a switch element drive unit driving the switch element with the switch element drive signal. The switch element control unit generates a new switch element control signal based on a switch element function diagnosis signal for diagnosing an abnormality in the switch element or in the switch element drive unit and on a switch element functional abnormality detection signal that includes an indication of a presence or an absence of the abnormality. The switch element control unit generates a new switch element drive signal based on the new switch element control signal and on the switch element function diagnosis signal.

### BACKGROUND

The present invention relates to an electric heating device for a vehicle which may be used, for example, in an air conditioner for an electric automobile, a fuel cell automobile, or a hybrid automobile.

In a vehicle, such as, for example, an automobile, an air conditioner (an air conditioning system) may be provided for adjusting a temperature in a vehicle compartment.

Such an air conditioner may normally be provided with a heating device for heating air conditioned air using the heat of engine cooling water. However, in a vehicle which does not use an engine as a drive source, such as, for example, an electric automobile or a fuel cell automobile, the heat of the engine cooling water cannot be used as a source for heating. In a hybrid automobile, it is difficult to satisfactorily use the heat of engine cooling water. Accordingly, instead of engine cooling water, a heat medium in the form of a liquid (a liquid heat medium) heated with a heater is fed to the heating device described above to heat the air conditioned air. For this purpose, an electric heating device for heating the liquid heat medium described above may be used (see, e.g., Japanese Patent Application Laid-open No. 2010-179889).

Examples of such an electric heater used therefor include a heater using a positive temperature coefficient (PTC) element which generates heat upon flow of an electric current therethrough and a sheathed heater using a nichrome wire. As to the types of failures which may occur in a switch element for allowing an electric current to flow through the heating element of such an electric heater and in a drive circuit for driving the switch element, two types are assumed. They are a short-circuit failure resulting from the short-circuiting of a part of the drive circuit or the switch element and an open failure resulting from the disconnection of a part of the drive circuit or the switch element. According to the disclosure in Japanese Patent Application Laid-open No. 2010-179889, the problem occurs that a short-circuit failure may be detected, but an open failure may not be detected.

### SUMMARY

Embodiments of the present invention has been designed in consideration of the circumstances described above, and some embodiments of the present invention provides an electric heating device for a vehicle which allows, even if a switch element for allowing an electric current to flow through the heating element of an electric heater or a drive circuit for driving the switching element incurs a short-circuit failure or an open failure, easy and reliable detection of the failure to allow reliable breakage of a circuit that allows the electric current to flow through the electric heater.

An electric heating device for a vehicle according to an embodiment of the present invention reliably detects the occurrence of a short-circuit failure or an open failure in a switch element configured to allow an electric current to flow through a heating element or in a drive circuit which drives the switch element and reliably breaks a circuit that allows the electric current to flow through the electric element.

An electric heating device for a vehicle according to one embodiment of the present invention includes: a switch element configured to allow an electric current to flow through an electric heater; a switch element control unit configured to generate a switch element control signal, and a switch element drive signal for driving the switch element based on the switch element control signal; and a switch element drive unit configured to drive the switch element with the switch element drive signal. The switch element control unit is configured to generate a new switch element control signal based on a switch element function diagnosis signal for diagnosing an abnormality in the switch element or in the switch element drive unit and based on a switch element functional abnormality detection signal obtained when the switch element is driven with the switch element drive signal. The switch element functional abnormality detection signal includes an indication of a presence or an absence of the abnormality in the switch element or in the switch element drive unit. The switch element control unit is configured to generate a new switch element drive signal based on the new switch element control signal and based on the switch element function diagnosis signal.

The electric heating device for a vehicle may be configured to compare, with the switch element function diagnosis signal, the switch element functional abnormality detection signal which is output from the switch element functional abnormality detection unit when the switch element which allows the electric current to flow through the electric heater is driven with the switch element drive signal and includes the presence or absence of an abnormality in the switch element or in the switch clement drive unit. This allows easy and reliable detection of the occurrence of a short-circuit failure or an open failure in the switch element or in the switch element drive unit.

In addition, the switch element which allows an electric current to flow through the electric heater may be driven with the switch element drive signal that has been generated based on the switch element control signal generated based on each of the switch element functional abnormality detection signal and the switch element function diagnosis signal and on the switch element function diagnosis signal. This may allow the driving of the switch element and the failure detection to be simultaneously performed.

Moreover, in the switch element control unit, the new switch element control signal may be generated based on the switch element function diagnosis signal and on the switch element functional abnormality detection signal, and the switch element drive unit may further drive the switch element using the new switch element drive signal generated based on the new switch element control signal and on the switch element function diagnosis signal. Therefore, it may be possible to simultaneously and continuously perform the driving of the switch element and the failure detection.

In the electric heating device for a vehicle according to a second aspect, the switch element functional abnormality detection unit may output, as the switch element functional abnormality detection signal, any one of a signal indicating that the switch element or the switch element drive unit has incurred a short-circuit failure, a signal indicating that the switch element or the switch element drive unit has incurred an open failure, and a signal indicating that each of the switch element and the switch element drive unit is normally operating without a failure.

In the electric heating device for a vehicle thus configured, the switch element functional abnormality detection unit may output, as the switch element functional abnormality detection signal, the signal corresponding to the presence or absence of a failure in each of the switch element which allows an electric current to flow through the electric heater and in the switch element drive unit, and the signal corresponding to the occurrence of a short-circuit failure or an opening failure. This allows reliable detection of a failure in the switch element or in the switch element drive unit.

In the electric heating device for a vehicle according to a third aspect, the switch element functional abnormality detection signal is generated by performing a logical EXCLUSIVE-OR operation between the switch element function diagnosis signal, and the signal indicating that the switch element or the switch element drive unit has incurred a short-circuit failure, the signal indicating that the switch element or the switch element drive unit has incurred an open failure, or the signal indicating that each of the switch element and the switch element drive unit is normally operating without a failure.

In the electric heating device for a vehicle thus configured, the switch element functional abnormality detection unit may recognize the presence or absence of a failure in the switch element which allows the electric current to flow through the electric heater or in the switch element drive unit and the occurrence of a short-circuit failure or an open failure using a simple logic circuit and output, as the switch element functional abnormality detection signal, a signal in accordance with the presence or absence of a failure and the type of the failure. This allows more reliable detection of a failure in the switch element or in the switch element drive unit.

In the electric heating device for a vehicle according to a fourth aspect, the switch element control unit may smooth and then invert the switch element functional abnormality detection signal to generate a new switch element control signal, and also may perform a logical AND operation between the new switch element control signal and the switch element function diagnosis signal to generate a new switch element drive signal.

In the electric heating device for a vehicle thus configured, when a short-circuit failure or an open failure occurs in the switch element or in the switch element drive unit, it may be possible to generate a new switch element drive signal using a simple logic circuit and drive the switch element. This allows reliable breakage of a circuit that allows the electric current to flow through the electric heater.

The electric heating device for a vehicle according to a fifth aspect may further include a temperature fuse disposed at a mid-point in a circuit that supplies a power source to the switch element drive unit so as to come in contact with a heat generating portion of the electric heater. The temperature fuse may be configured to be fused in the event of abnormal heat generation from the electric heater.

In the electric heating device for a vehicle thus configured, at a mid-point in the circuit that supplies the power source to the switch element drive unit, the temperature fuse may be disposed so as to come in contact with the heat generating portion of the electric heater. As a result, it may be possible to reliably detect not only a short-circuit failure or an open failure in the switch element or in the switch element drive unit, but also to fuse due to abnormal heat generation from the electric heater and reliably break the circuit that allows the electric current to flow through the electric heater.

In the electric heating device for a vehicle according to a sixth aspect, the switch element may be provided on each of upstream and downstream sides of the electric heater. Also, the switch element control unit which generates the switch element control signal for defining the ON/OFF state of the switch element, and the switch element drive signal for driving the switch element based on the switch element control signal may be provided on each of the upstream and downstream sides of the electric heater. Further, the switch element drive unit which drives the switch element with the switch element drive signal may be provided on each of the upstream and downstream sides of the electric heater. Additionally, the switch element functional abnormality detection unit which detects the presence or absence of an abnormality in the switch element or in the switch element drive unit, and outputs the switch element functional abnormality detection signal may be provided on each of the upstream and downstream sides of the electric heater. Upon detection of a short-circuit failure or an open failure on either one of the upstream and downstream sides of the electric heater, both of the switch elements are disconnected.

In the electric heating device for a vehicle thus configured, when a short-circuit failure or an open failure occurs in the switch element or in the switch element drive unit on either of the upstream and downstream sides of the electric heater, it may be possible to easily and reliably detect the occurrence of the failure and reliably break the circuit that allows the electric current to flow on the upstream side of the electric heater and the circuit that allows the electric current to flow on the downstream side of the electric heater. It may also be possible to simultaneously and continuously perform in the driving of the switch element and the failure detection.

According to another embodiment of the present invention, a method of heating a vehicle compartment in a vehicle, may comprise: generating a control signal with a control unit; driving a switch element via a drive unit with a drive signal that is generated based on the control signal, the switch element being connected to an electric heater in an air conditioning system in the vehicle such that a flow of electric current to the electric heater is controllable; generating a switch element function diagnosis signal for diagnosing an abnormality in the switch element or in the switch element drive unit; detecting, upon the driving the switch element, a presence or an absence of the abnormality in the switch element or in the drive unit; outputting a switch element functional abnormality detection signal including an indication of the presence or the absence of the abnormality in the switch element or in the switch element drive unit; generating a new control signal with the control unit based on the switch element function diagnosis signal and based on the switch element functional abnormality detection signal obtained when the switch element is driven with the switch element drive signal; and generating a new element drive signal based on the new control signal and based on the switch element function diagnosis signal.

The electric heating device for a vehicle according to various embodiment of the present invention may achieve the effect of allowing, when a short-circuit failure or an open failure occurs in a switch element that allows an electric current to flow through an electric heater or in a switch element drive unit, easy and reliable detection of the occurrence of the failure to allow reliable breakage of the circuit that allows the electric current to flow through the electric heater.

It is to be understood that both the foregoing general description and the following detailed descriptions are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a block diagram showing a schematic configuration of an electric heating device for a vehicle according to one embodiment of the present invention;

FIG. 2 is a flow chart showing the operation of the electric heating device for a vehicle according to the embodiment of the present invention;

FIG. 3A is a time chart showing the procedure of the generation of a switch element drive signal during a normal operation according to one embodiment of the present invention. FIG. 3B is a time chart showing the procedure of the generation of the switch element drive signal in the event of an abnormality according to one embodiment of the present invention;

FIG. 4A is a time chart showing the generation of a switch element control signal during the normal operation according to one embodiment of the present invention.

FIG. 4B is a time chart showing the generation of the switch element control signal in the event of an open failure according to one embodiment of the present invention.

FIG. 4C is a time chart showing the generation of the switch element control signal in the event of a short-circuit failure according to one embodiment of the present invention;

FIG. 5 is a view showing an example of a circuit configuration of an upstream switch element functional abnormality detection unit of the electric heating device for a vehicle according to one embodiment of the present invention;

FIG. 6 is a view showing an example of a circuit configuration of an upstream switch element control unit of the electric heating device for a vehicle according to the embodiment of the present invention; and

FIG. 7 is a block diagram showing a schematic configuration of the electric heating device for a vehicle according to another embodiment of the present invention.

### DETAILED DESCRIPTION

Referring now to the drawings, a description will be given of an electric heating device for a vehicle according to embodiments of the present invention.

### First Embodiment

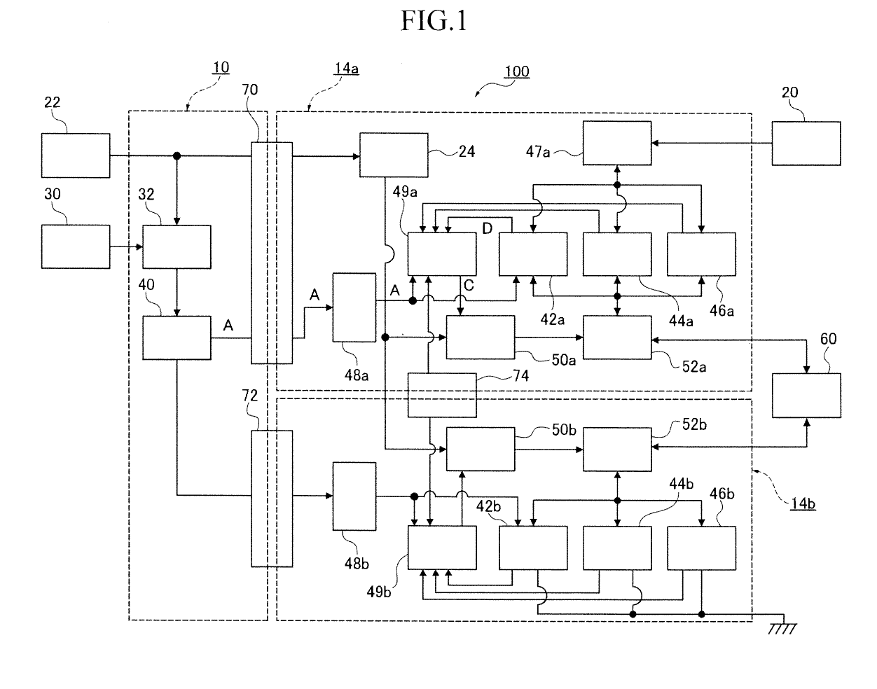

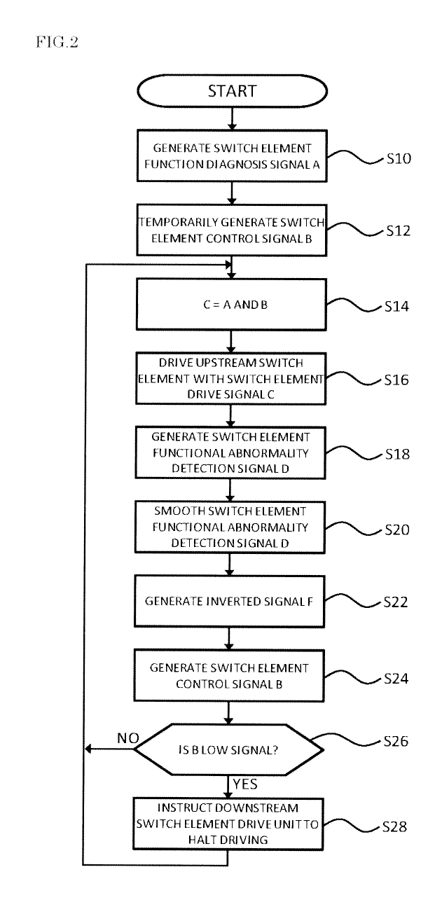

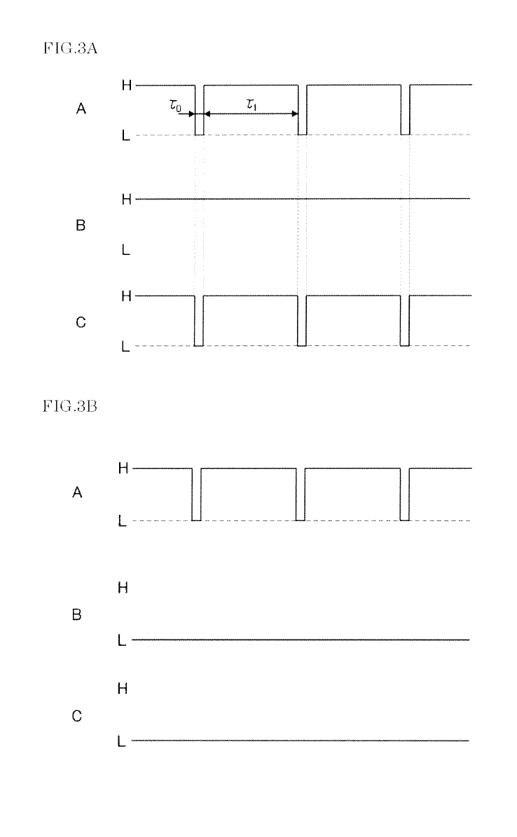

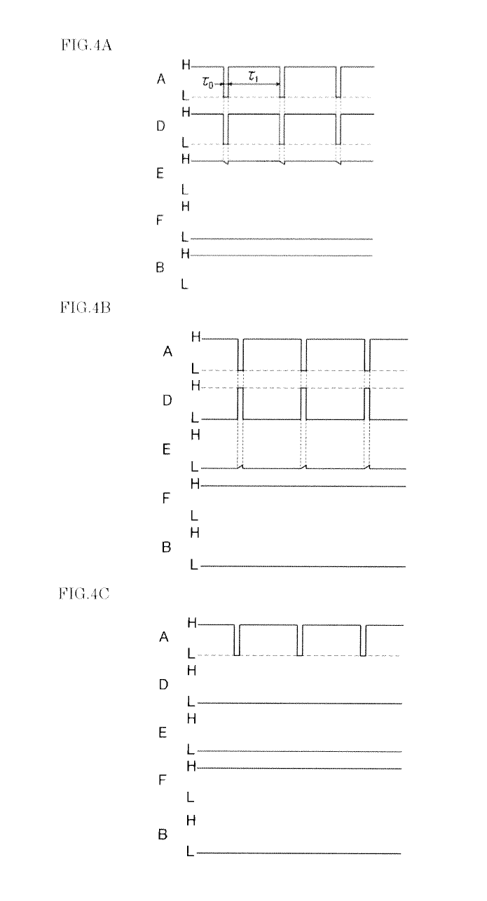

In a first embodiment, the present invention may be applied to an electric heater for a vehicle. Using the block diagram of FIG. 1, the flow chart of FIG. 2, and the time charts of FIGS. 3 and 4, the first embodiment of the present invention will be described below.

[Mechanical Configuration]

An electric heating device for a vehicle 100 may be disposed in a vehicle not shown.

As shown in FIG. 1, the electric heating device for a vehicle 100 may include an electric heater 60, an upstream electric heater drive unit 14a, a downstream electric heater drive unit 14b, a high-voltage power source 20, a battery power source 22, an air conditioning controller 30, and an interface unit 10.

A heater using a positive temperature coefficient (PTC) element which generates heat upon the flow of an electric current therethrough, a sheathed heater using a nichrome wire, or the like may be used as the electric heater 60.

The upstream electric heater drive unit 14a may generate a control signal for heating on the upstream side of the electric heater 60. On the other hand, the downstream electric heater drive unit 14b may generate a control signal for heating on the downstream side of the electric heater 60.

The upstream electric heater drive unit 14a and the downstream electric heater drive unit 14b are thus separately disposed to provide a double system and thereby allow reliable failure detection in the event of the occurrence of a failure.

The upstream electric heater drive unit 14a may include a switch element driving power source 24, an upstream switch element functional abnormality detection unit 42a (a switch element functional abnormality detection unit), an upstream excess heat detection unit 44a, an upstream excess current detection unit 46a, an upstream excess voltage detection unit 47a, an upstream signal interruption detection unit 48a, an upstream switch element control unit 49a (a switch element control unit), an upstream switch element drive unit 50a (a switch element drive unit), and an upstream switch element 52a (a switch element).

The switch element driving power source 24 may be generated from the battery power source 22 and has a predetermined voltage value coincident with the design value of the upstream electric heater drive unit 14a. The switch element driving power source 24 may be supplied to the upstream switch element drive unit 50a to control the flow of the electric current to the upstream switch element 52a.

The upstream switch element functional abnormality detection unit 42a may detect the occurrence of a short-circuit failure or an open failure in the upstream switch element 52a, which allows the electric current to flow through the electric heater 60, or in the upstream switch element drive unit 50a.

The upstream excess heat detection unit 44a may use an excess heat detecting element such as, for example, a thermosensitive element such as, for example, a thermistor or a Schottky barrier diode, for the temperature detection to detect excess heat in a circuit board.

The upstream excess current detection unit 46a may use a low-resistance resistor element such as, for example, a current detection resistor (for example, a shunt resistor) to detect an excess current flowing in the upstream switch element drive unit 50a and the upstream switch element 52a.

The upstream excess voltage detection unit 47a may use a comparison element such as, for example, a comparator to detect an excess voltage.

The upstream signal interruption detection unit 48a may check whether or not a predetermined switch element function diagnosis signal A is generated to detect a circuit failure in the interface unit 10.

The upstream switch element control unit 49a may generate and output a switch element drive signal C for controlling the operation of the upstream switch element drive unit 50a.

The upstream switch element drive unit 50a may use the switch element drive signal C to control the flow of the electric current to the upstream switch element 52a and perform a switching operation.

The upstream switch element 52a may control the flow of the electric current to the electric heater 60. As the switching element, a transistor such as, for example, an insulated gate bipolar transistor (IGBT) may typically be used.

On the other hand, the downstream electric heater drive unit 14b may include a downstream switch element functional abnormality detection unit 42b, a downstream excess heat detection unit 44b, a downstream excess current detection unit 46b, a downstream signal interruption detection unit 48b, a downstream switch element control unit 49b, a downstream switch element drive unit 50b, and a downstream switch element 52b.

As can be seen in the embodiment of FIG. 1, the downstream electric heater drive unit 14b has a configuration like that of the upstream electric heater drive unit 14a but the component corresponding to the upstream excess voltage detection unit 47a from the upstream electric heater drive unit 14a is removed. As such, a detailed description of the components of the downstream electric heater drive unit 14b is omitted.

The high-voltage power source 20 may be a high-voltage DC power source of, for example, a 100-400 V type which is supplied to the electric heater 60.

The battery power source 22 may be, for example, a 12 V DC power source which is supplied from a battery mounted in the vehicle and may be used in the upstream electric heater drive unit 14a and the downstream electric heater drive unit 14b to generate a control signal for driving the electric heater 60. Since the control signal may normally be generated by a TTL circuit or a CMOS circuit, the battery power source 22 may be converted to a power source voltage used in the TTL circuit or the CMOS circuit and supplied (the configuration of the conversion unit for the power source voltage is well known and therefore the illustration thereof is omitted).

The air conditioning controller 30 may control the driven state of the electric heater 60 based on an instruction from a vehicle passenger or the state of an air conditioning environment in a vehicle compartment.

The interface unit 10 may include an external interface unit 32, and a switch element function diagnosis signal generation unit 40.

The external interface unit 32 may transmit an instruction from the air conditioning controller 30 to the upstream electric heater drive unit 14a and to the downstream electric heater drive unit 14b.

The switch element function diagnosis signal generation unit 40 may generate the switch element function diagnosis signal A for detecting a failure in the upstream switch element drive unit 50a, the downstream switch element drive unit 50b, the upstream switch element 52a, or the downstream switch element 52b, each of which will described later.

Between the interface unit 10 and the upstream electric heater drive unit 14a, an upstream signal isolation unit 70 may be disposed to provide electrical insulation between a high-voltage circuit and a low-voltage circuit. As a result, the interface unit 10 and the upstream electric heater drive unit 14a may be in an electrically isolated state. The upstream signal isolation unit 70 may be implemented specifically by a method which uses a radio-frequency transformer to provide electrical isolation between an input unit and an output unit, a method which converts an electric signal to a light signal to provide electrical isolation between the input unit and the output unit, or the like.

Between the interface unit 10 and the downstream electric heater drive unit 14b, a downstream signal isolation unit 72, similarly to the upstream signal isolation unit 70, may be provided. As a result, the interface unit 10 and the downstream electric heater drive unit 14b may be in an electrically isolated state.

Between the upstream electric heater drive unit 14a and the downstream electric heater drive unit 14b, a middle-up-downstream signal isolation unit 74 may be provided. As a result, the upstream electric heater drive unit 14a and the downstream electric heater drive unit 14b may be in an electrically isolated state.

[Description of Function]

Next, the function of failure detection in the electric heating device for a vehicle 100 according to one embodiment of the present invention will be described sequentially.

The electric heating device for a vehicle 100 shown in FIG. 1 includes a failure detecting function shown below.

First, the upstream signal interruption detection unit 48a detects an abnormality in the circuit of the interface unit 10.

Then, the upstream excess heat detection unit 44a detects excess heat in the circuit board on which the upstream switch element drive unit 50a and the upstream switch element 52a are mounted.

Also, the upstream excess current detection unit 46a detects an excess current flowing in the upstream switch element drive unit 50a and the upstream switch element 52a.

Further, the upstream excess voltage detection unit 47a detects the application of an excess voltage to the upstream switch element 52a or to the electric heater 60.

Then, the upstream switch element functional abnormality detection unit 42a detects an open failure resulting from disconnection of a part of an element or a circuit or a short-circuit failure resulting from short-circuiting of a part of the element or the circuit in the upstream switch element 52a or in the upstream switch element drive unit 50a.

Of the failure detection described above, each of the detection of an abnormality in the circuit of the interface unit 10, the detection of excess heat in the circuit board, the detection of an excess current flowing in the circuit, and the detection of an excess voltage applied to the circuit is a known technique.

One of the main advantages of the present invention resides in the ability of the upstream switch element functional abnormality detection unit 42a to detect both of an open failure and a short-circuit failure in the upstream switch element 52a and in the upstream switch element drive unit 50a.

The downstream electric heater drive unit 14b includes the same failure detecting function as that of the upstream electric heater drive unit 14a. Since each of the downstream electric heater drive unit 14b and the upstream electric heater drive unit 14a performs exactly the same function, in the following description, only the failure detection in the upstream electric heater drive unit 14a will be described, while the description of the operation of the downstream electric heater drive unit 14b is omitted.

Using the flow chart of FIG. 2 and the time charts of FIGS. 3 and 4, a description will be given below of a method of detecting an open failure and a short-circuit failure implemented by the upstream switch element functional abnormality detection unit 42a.

(Step S10) When the air conditioning control in the vehicle compartment is started by the air conditioning controller 30, the switch element function diagnosis signal A is generated in the switch element function diagnosis signal generation unit 40.

The switch element function diagnosis signal A is generated by the TTL logic or the CMOS logic. As shown in FIG. 3A, the switch element function diagnosis signal A is a pulse train having a LOW level sustained over a predetermined time τ₀ between HIGH signal levels each sustained over a predetermined time τ₁. Here, a short time which does not affect the operation of the electric heater 60 even when the electric heater 60 is activated by the switch element function diagnosis signal A is set as the predetermined time τ₀. A specific example of a circuit for generating the switch element function diagnosis signal A is not shown, but can be easily produced using a known oscillation circuit or a frequency divider circuit.

(Step S12) In the upstream switch element control unit 49a, a switch element control signal B is temporarily generated.

As will be described later, the switch element control signal B is generated based on the output of the upstream switch element functional abnormality detection unit 42a which is produced upon actual switching of the upstream switch element 52a. However, since the upstream switch element 52a is not switched during the first operation in the flow chart of FIG. 2, a signal in which the HIGH level is sustained irrespective of time (hereinafter referred to as “HIGH signal”) is generated as a temporary switch element control signal B. Here, the HIGH level of the switch element control signal B means bringing the switch element into a conducting (ON) state, and the LOW level of the switch element control signal B means bringing the switch element into a non-conducting (OFF) state.

(Step S14) In the upstream switch element control unit 49a, the switch element drive signal C is generated.

Specifically, as shown in FIG. 3A, by performing a logical AND operation between the switch element function diagnosis signal A and the switch element control signal B, the switch element drive signal C is generated. During the first operation in the flow chart of FIG. 3, the switch element control signal B is a HIGH signal so that the switch element drive signal C is the same as the switch element function diagnosis signal A (see FIG. 3A). Here, the logical AND operation is performed for the purpose of performing failure detection for the upstream switch element 52a and the upstream switch element drive unit 50a at the same time as the switch element function diagnosis signal A is superimposed on the switch element control signal B to drive the upstream switch element 52a.

The switch element drive signal C is actually implemented using the circuit of FIG. 6 mounted in the upstream switch element control unit 49a (a switch element control unit), which will be described later. The temporary switch element control signal B generated in Step S12 represents a signal output from an output terminal O₇ in FIG. 6.

(Step S16) The switch element drive signal C generated in Step S14 is input to the upstream switch element drive unit 50a, and the upstream switch element drive unit 50a performs a switching operation for controlling the flow of the electric current to the upstream switch element 52a in accordance with the switch element drive signal C. Then, the upstream switch element 52a responds to the switch element drive signal C to perform an ON/OFF operation (an ON operation is performed when the switch element drive signal C is HIGH and an OFF operation is performed when the switch element drive signal C is LOW). As a result, over a period during which the upstream switch element 52a is ON, the voltage supplied from the high-voltage power source 20 is applied to the electric heater 60 to activate the electric heater 60.

(Step S18) While the electric heater 60 is activated, in the upstream switch element functional abnormality detection unit 42a, the presence or absence of the occurrence of a failure in the upstream switch element drive unit 50a or in the upstream switch element 52a is detected, and a switch element functional abnormality detection signal D including the presence or absence of a failure and the content of the failure is generated. The switch element functional abnormality detection signal D thus generated is input to the upstream switch element control unit 49a.

Specifically, when a short-circuit failure or an open failure occurs in the upstream switch element drive unit 50a or in the upstream switch element 52a, the upstream switch element functional abnormality detection unit 42a detects the failure.

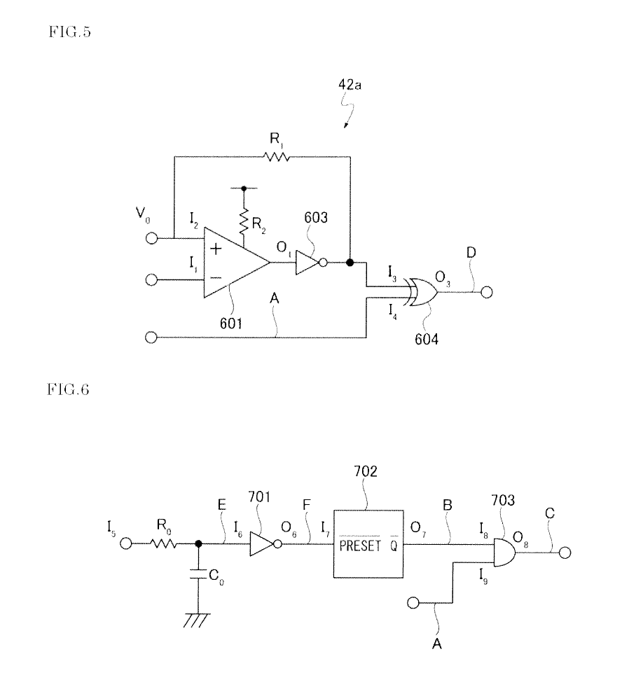

FIG. 5 shows an example of a circuit configuration in the upstream switch element functional abnormality detection unit 42a. The circuit has an input terminal I₁ and an input terminal I₂. To the input terminal I₂, a predetermined voltage V₀ set in advance is applied. The circuit may include a comparator 601 which operates as an inverting amplifier for the signal input to the input terminal I₁, an inverter 603 connected to the output stage of the comparator 601 to invert the HIGH and LOW levels of the signal, and an arithmetic operation element 604 which performs a logical EXCLUSIVE-OR operation. To provide the output of the comparator 601 with hysteresis, the output stage of the inverter 603 and the input terminal I₁ are connected via a resistor having a resistance value R₁. A driving power source for the comparator 601 is connected to the comparator 601 via a resistor having a resistance value R₂.

The input terminal I₁ which is one of the two input terminals of the comparator 601 is connected to the upstream switch element 52a.

The output of the inverter 603 is connected to an input terminal I₃, which is one of the two terminals of the arithmetic operation element 604. The switch element function diagnosis signal A is connected to the other input terminal I₄ of the arithmetic operation element 604. From an output terminal O₃ of the arithmetic operation element 604, the switch element functional abnormality detection signal D is output.

When a short-circuit failure occurs in the upstream switch element drive unit 50a or in the upstream switch element 52a, the switch element function diagnosis signal A is input to the input terminal I₁ of the comparator 601. At this time, the switch element function diagnosis signal A is output to the output terminal of the inverter 603 and input to the input terminal I₃ of the arithmetic operation element 604.

When the switch element function diagnosis signal A is thus input to the input terminal I₃ of the arithmetic operation element 604, and because the switch element function diagnosis signal A has also been input to the input terminal I₄ of the arithmetic operation element 604, a LOW signal is output from the arithmetic operation element 604 which performs the logical EXCLUSIVE-OR operation. Consequently, the LOW signal is output from the output terminal O₃ of the arithmetic operation element 604.

The LOW signal output from the output terminal O₃ is output as the switch element functional abnormality detection signal D (see FIG. 4C) and input to the upstream switch element control unit 49a.

On the other hand, when an open failure occurs in the upstream switch element drive unit 50a or in the upstream switch element 52a, a HIGH signal in the TTL logic or the CMOS logic is input to the input terminal I₁ of the comparator 601. At this time, the HIGH signal is output to the output terminal of the inverter 603 and input to the input terminal I₃ of the arithmetic operation element 604.

When the HIGH signal is thus input to the input terminal I₃ of the arithmetic operation element 604, and because the switch element function diagnosis signal A has been input to the input terminal I₄ of the arithmetic operation element 604, the arithmetic operation element 604 which performs the logical EXCLUSIVE-OR operation outputs the inverted waveform of the switch element function diagnosis signal A. Accordingly, the signal obtained by inverting the switch element function diagnosis signal A is output from the output terminal O₃ of the arithmetic operation element 604.

The inverted signal of the switch element function diagnosis signal A output from the output terminal O₃ is output as the switch element functional abnormality detection signal D (see FIG. 4B). The switch element functional abnormality detection signal D is input to the upstream switch element control unit 49a.

When each of the upstream switch element drive unit 50a and the upstream switch element 52a is normally operating without a failure, the LOW signal in the TTL logic or the CMOS logic is input to the input terminal I₁ of the comparator 601. At this time, the LOW signal is output from the output terminal of the inverter 603 and input to the input terminal I₃ of the arithmetic operation element 604.

When the LOW signal is thus input to the input terminal I₃ of the arithmetic operation element 604, and because the switch element function diagnosis signal A has been input to the input terminal I₄ of the arithmetic operation element 604, the arithmetic operation element 604 which performs the logical EXCLUSIVE-OR operation outputs the switch element function diagnosis signal A. Consequently, the switch clement function diagnosis signal A is output from the output terminal O₃ of the arithmetic operation element 604.

The switch element function diagnosis signal A output from the output terminal O₃ is output as the switch element functional abnormality detection signal D (see FIG. 4A). The switch element functional abnormality detection signal D is input to the upstream switch element control unit 49a.

Note that the HIGH/LOW signal levels are not limited to those described above. It will be appreciated that the logic thereof may also be inverted. Also, the circuit configuration shown in FIG. 5 is not limited to that shown in the drawing. Any configuration may be used as long as the same logic configuration can be implemented thereby.

Referring back to FIG. 2, the switch element functional abnormality detection signal D generated in Step S18 is input to the upstream switch element control unit 49a. By the circuit shown in FIG. 6, processing in the steps including and subsequent to Step S20 may be performed.

Here, a description will be given of the circuit configuration of FIG. 6. The circuit of FIG. 6 is configured as a follows. The switch element functional abnormality detection signal D is input to an input terminal I₅ and passes through a CR circuit including a resistor having a resistance value R₀ and a capacitor having a capacitance value C₀ to be input to an inverter 701 which inverts the signal level of the switch element functional abnormality detection signal D at an input terminal I₆. The output of the inverter 701 from an output terminal O₆ is stabilized and input via an input terminal I₇ to a flip-flop 702 for generating the switch element control signal B. The switch element control signal B as the output of the flip-flop 702 is output from the output terminal O₇ and input from an input terminal I₈ to the arithmetic operation element 703, which performs a logical AND operation between the switch element control signal B and the switch element function diagnosis signal A input via an input terminal I₉ to the arithmetic operation element 703. The logical AND thus obtained is output as the switch element drive signal C from an output terminal O₈.

(Step S20) In Step S20, signal processing for smoothing the switch element functional abnormality detection signal D generated in Step S18 is performed. Referring back to the circuit in FIG. 6, the smoothing of the signal is performed by the CR circuit including the resistor having the resistance value R₀ and the capacitor having the capacitance value C₀, which is mounted in the upstream switch element control unit 49a and disposed in the stage previous to the inverter 701 shown in FIG. 6.

By the smoothing processing, a smoothed signal E is generated as the output of the CR circuit in FIG. 6. Specific examples of the smoothed signal E are shown in FIGS. 4A to 4C.

When each of the upstream switch element drive unit 50a and the upstream switch element 52a is normally operating without a failure, as shown in FIG. 4A, voltage fluctuations due to a negative pulse in the predetermined time τ₀ are smoothed to provide the smoothed signal E which can be regarded as a generally HIGH signal.

When an open failure occurs in the upstream switch element drive unit 50a or in the upstream switch element 52a, as shown in FIG. 4B, voltage fluctuations due to a positive pulse in the predetermined time τ₀ are smoothed to provide the smoothed signal E which can be regarded as a generally LOW signal.

When a short-circuit failure occurs in the upstream switch element drive unit 50a or in the upstream switch element 52a, as shown in FIG. 4C, the LOW signal is obtained as the smoothed signal E. This is because, even when the LOW signal having a constant voltage level is smoothed, the smoothing achieves no effect so that the same output signal as the input signal is obtained.

Because the resistance value R₀ and the capacitance value C₀ each used in the CR circuit for performing smoothing differ depending on the predetermined time τ₀, elements having values properly set by experiment or the like are used.

(Step S22) Next, in Step S22, the smoothed signal E is input to the inverter 701 to have the signal level thereof inverted to generate an inverted signal F. Examples of the inverted signal F thus generated are shown in FIGS. 4A to 4C.

(Step S24) Next, in Step S24, the inverted signal F is input to the input terminal I₇ as the preset terminal of the flip flop 702 to cause the signal output from the output terminal O₇ of the flip-flop 702 to serve as the switch element control signal B. Here, the inverted signal F is caused to pass through the flip-flop 702 for the stabilization of the switch element control signal B. At this time, by causing the inverted signal F to pass through the flip-flop 702, the level of the inverted signal F is inverted again.

When each of the upstream switch element drive unit 50a and the upstream switch element 52a is normally operating without a failure, a HIGH signal is obtained as the switch element control signal B. When an open failure or a short-circuit failure occurs in the upstream switch element drive unit 50a or in the upstream switch element 52a, a LOW signal is obtained as the switch element control signal B.

(Step S26) Next, it is determined whether or not the switch element control signal B is a LOW signal. When the switch element control signal B is a LOW signal (when an open failure or a short-circuit failure has occurred in the upstream switch element drive unit 50a or in the upstream switch element 52a), the process advances to Step S28. When the switch element control signal B is not a LOW signal (when the switch element control signal B is a HIGH signal), the process returns to Step S14.

(Step S28) From the upstream switch element control unit 49a to the downstream switch element control unit 49b, a signal for halting the operation on the downstream side of the electric heater 60 is transmitted.

Upon receipt of the signal, the downstream switch element control unit 49b outputs a LOW signal as the switch element drive signal C for halting the operation of the downstream switch element 52b to the downstream switch element drive unit 50b. The downstream switch element drive unit 50b drives the downstream switch element 52b in accordance with the LOW signal. However, since the switch element drive signal C is the LOW signal, a switching operation is not performed. The switch element is disconnected so that operation on the downstream side of the electric heater 60 is halted.

(Step S14) In the upstream switch element control unit 49a, a logical AND operation is performed between the switch element control signal B generated in Step S24 and the switch element function diagnosis signal A to synthetically generate the switch element drive signal C. Here, when each of the upstream switch element drive unit 50a and the upstream switch element 52a is normally operating without a failure, the switch element function diagnosis signal A is obtained as the switch element drive signal C. When an open failure or a short-circuit failure occurs in the upstream switch element drive unit 50a or in the upstream switch element 52a, a LOW signal is obtained as the switch element drive signal C.

(Step S16) The switch element drive signal C generated in Step S14 is supplied to the upstream switch element drive unit 50a. With the switch element drive signal C, the upstream switch element drive unit 50a drives the upstream switch element 52a.

Here, when each of the upstream switch element drive unit 50a and the upstream switch element 52a is normally operating without a failure, a switching operation is performed with the switch element function diagnosis signal A to cause conduction in the upstream switch element 52a and operation on the upstream side of the electric heater 60. On the other hand, when an open failure or a short-circuit failure occurs in the upstream switch element drive unit 50a or in the upstream switch element 52a, the switch element drive signal C is a LOW signal so that the switching operation is not performed such that the upstream switch element 52a is disconnected and operation on the upstream side of the electric heater 60 is halted.

The description has thus been given of the method of the failure detection performed in the upstream electric heater drive unit 14a. However, the same failure detection is performed also in the downstream electric heater drive unit 14b. In addition, on the downstream side also, a circuit of the same configuration as that of the circuit described with reference to FIGS. 5 and 6 is formed.

Note that, in the circuit of FIG. 6, the signal level is inverted after the switch element functional abnormality detection signal D is smoothed. However, even when the smoothing is performed after the signal level of the switch element functional abnormality detection signal D is inverted, the same result is obtainable. Therefore, the procedure of signal processing is arbitrary.

The description has thus been given of the flow of the failure detection in the upstream switch element functional abnormality detection unit 42a. Note that, in an actual situation, failure detection in the other portions (the upstream signal interruption detection unit 48a, the upstream excess heat detection unit 44a, the upstream excess current detection unit 46a, and the upstream excess voltage detection unit 47a) is also performed in parallel, though not shown in FIG. 2. When an abnormality is detected in any of the portions, the upstream switch element control unit 49a is configured to output the switch element drive signal C as a LOW signal to the upstream switch element drive unit 50a, and also the upstream switch element drive unit 50a is configured to output the switch element drive signal C for disconnecting the upstream switch element 52a to the upstream switch element 52a.

The overall circuit configuration of the upstream switch element control unit 49a can be as follows, though not shown: an output of each of the detection units (42a, 44a, 46a, 47a, and 48a) is input to an arithmetic element which performs a logical OR operation and, after the detection of an abnormality in at least one of the detection units is detected, a LOW signal is generated and used as the switch element control signal B.

As has been described thus far, the electric heating device for a vehicle according to the first embodiment is configured to compare, with the switch element function diagnosis signal A, the switch element functional abnormality detection signal D which is output from the upstream switch element functional abnormality detection unit 42a (a switch element functional abnormality detection unit) when the upstream switch element 52a (a switch element) that allows the electric current to flow through the electric heater 60 is driven with the switch element drive signal C and includes the presence or absence of an abnormality in the upstream switch element 52a (the switch element) or in the upstream switch element drive unit 50a (a switch element drive unit) and the content of the abnormality. This allows easy and reliable detection of the occurrence of a short-circuit failure or an open failure in the upstream switch element 52a (switch element) or in the upstream switch element drive unit 50a (switch element drive unit).

In addition, the upstream switch element 52a (switch element) that allows the electric current to flow through the electric heater 60 is driven with the switch element drive signal C that has been generated based on the switch element control signal B generated based on each of the switch element functional abnormality detection signal D and the switch element function diagnosis signal A and on the switch element function diagnosis signal A. This allows the driving of the upstream switch element 52a (switch element) and the failure detection to be simultaneously performed.

Moreover, in the upstream switch element control unit 49a (switch element control unit), the new switch element control signal B is generated based on the switch element functional abnormality detection signal D and on the switch element function diagnosis signal A, and the upstream switch element drive unit 50a (switch element drive unit) further drives the upstream switch element 52a (switch element) using the new switch element drive signal C generated based on the new switch element control signal B and on the switch element function diagnosis signal A. Therefore, it is possible to simultaneously and continuously perform the driving of the upstream switch element 52a (switch element) and the failure detection.

Also, in the electric heating device for a vehicle according to the first embodiment, the upstream switch element functional abnormality detection unit 42a (switch element functional abnormality detection unit) may output, as the switch element functional abnormality detection signal D, a signal in accordance with the presence or absence of a failure in the upstream switch element 52a (a switch element) or in the upstream switch element drive unit 50a (a switch element drive unit) or with the occurrence of a short-circuit failure or an open failure. This allows reliable detection of a failure in the upstream switch element 52a (the switch element) or in the upstream switch element drive unit 50a (the switch element drive unit).

Further, in the electric heating device for a vehicle according to the first embodiment, the upstream switch element functional abnormality detection unit 42a (a switch element functional abnormality detection unit) can recognize the presence or absence of a failure in the upstream switch element 52a (a switch element) or in the upstream switch element drive unit 50a (a switch element drive unit) or the occurrence of a short-circuit failure or an open failure using a simple logic circuit and output, as the switch element functional abnormality detection signal D, a signal in accordance with the presence or absence of a failure and the type of the failure. This allows more reliable detection of a failure in the upstream switch element 52a (the switch element) or in the upstream switch element drive unit 50a (the switch element drive unit).

Additionally, in the electric heating device for a vehicle according to the first embodiment, when a short-circuit failure or an open failure occurs in the upstream switch element 52a (a switch element) or in the upstream switch element drive unit 50a (a switch element drive unit), it is possible to generate the new switch element drive signal C using a simple logic circuit and drive the upstream switch element 52a (the switch element). This allows reliable breakage of a circuit that allows the electric current to flow through the electric heater.

Also, in the electric heating device for a vehicle according to the first embodiment, when a short-circuit failure or an open failure occurs in the upstream switch element 52a (a switch element) or the upstream switch element drive unit 50a (a switch element drive unit) on either of the upstream and downstream sides of the electric heater 60, it is possible to reliably detect the occurrence of the failure and reliably break a circuit that allows the electric current to flow on the upstream side of the electric heater 60 and a circuit that allows the electric current to flow on the downstream side of the electric heater 60.

### Second Embodiment

In the second embodiment, the present invention is applied to an electric heater for a vehicle. In particular, the second embodiment is characterized by the ability to reliably detect the fusing of a temperature fuse disposed to protect the electric heater resulting from a temperature increase due to abnormal heat generation from the electric heater using the mechanism of the failure detection described in the first embodiment and cut off the power supply of a power source to the electric heater.

The second embodiment of the present invention will be described below using FIGS. 3, 4, and 7.

[Mechanical Configuration]

With regard to a mechanical configuration of an air conditioner for a vehicle according to another embodiment of the present invention, a description will be given only of the differences between this second embodiment and the first embodiment (FIG. 1).

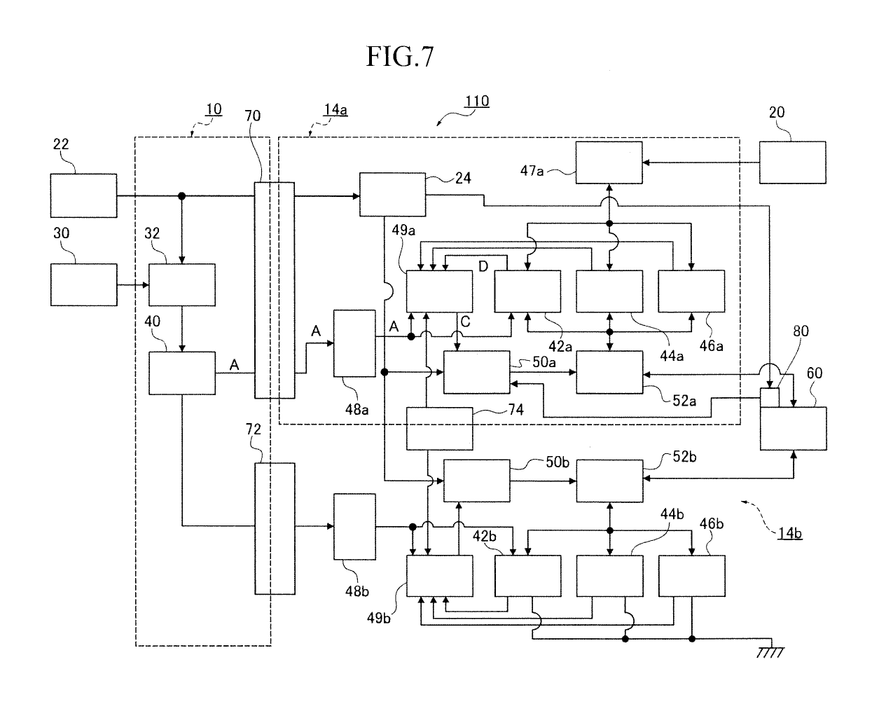

As shown in FIG. 7, an electric heating device for a vehicle 110 may include, in addition to the configuration of the electric heating device for a vehicle 100 described in the first embodiment (see FIG. 1), a temperature fuse 80 disposed at a mid-point in a circuit that supplies the switch element driving power source 24 to the upstream switch element drive unit 50a so as to come in contact with the heat generating portion of the electric heater 60. The temperature fuse 80 is capable of being fused in the event of abnormal heat generation from the electric heater 60.

The temperature fuse 80 may have a structure obtained by: joining a fusible conductive material made of a low-melting-point alloy which is fused at a set temperature and placed between two lead wires with the two lead wires; circumferentially coating the fusible conductive material with a resin; inserting the fusible conductive material coated with the resin into an insulating case made of a ceramic; and sealing the both ends of the insulating case with an epoxy resin.

The temperature fuse 80 may also have a structure in which the fusible conductive material that has reached a melting point due to an increase in ambient temperature and been fused is condensed at the both ends of the lead wires to be divided. This breaks the circuit to which the temperature fuse 80 is connected.

[Description of Function]

With regard to the function of the electric heating device for a vehicle 110 according to the second embodiment of the present invention, a description will be given only of the differences between the second embodiment and the first embodiment.

The temperature fuse 80 may be disposed at a place on the surface of the electric heater having excellent heat conduction so as to directly sense heat generation from the electric heater 60 and allow the two lead wires and the insulating case to be uniformly heated.

When an abnormality occurs in the electric heater 60 or in the peripheral circuit of the electric heater 60 to cause abnormal heat generation from the electric heater 60, the temperature fuse 80 disposed so as to come in contact with the heat generating portion of the electric heater 60 is fused to bring the circuit that supplies the switch element driving power source 24 to the upstream switch element drive unit 50a into an open state.

At this time, the switch element functional abnormality detection signal D showing that an open failure has occurred in the upstream switch element drive unit 50a is transmitted from the upstream switch element functional abnormality detection unit 42a to the upstream switch element control unit 49a.

Consequently, by the signal processing described with respect to the first embodiment, a LOW signal is generated as the switch element control signal B (see FIG. 4B). Further, a LOW signal is generated as the switch element drive signal C (see FIG. 3B) and supplied to the upstream switch element drive unit 50a.

Then, from the upstream switch element drive unit 50a to the upstream switch element 52a, the LOW signal is output as the switch element drive signal C for disconnecting the upstream switch element 52a to halt operation on the upstream side of the electric heater 60.

At this time, a signal for halting operation on the downstream side of the electric heater 60 is transmitted from the upstream switch element control unit 49a to the downstream switch element control unit 49b. After receiving the signal, the downstream switch element control unit 49b outputs a LOW signal to the downstream switch element drive unit 50b. This disconnects the downstream switch element 52b and halts operation on the downstream side of the electric heater 60.

Thus, as described above, in the electric heating device for a vehicle 110 according to the second embodiment, the temperature fuse 80 may be disposed at a mid-point in the circuit the supplies the switch element driving power source 24 to the upstream switch element drive unit 50a (a switch element drive unit) so as to come in contact with the heat generating portion of the electric heater 60. As a result, it is possible to reliably detect not only a short-circuit failure or an open failure in the upstream switch element 52a (a switch element) or in the upstream switch element drive unit 50a (a switch element drive unit), but also the fusing of the temperature fuse 80 resulting from abnormal heat generation from the electric heater 60 and reliably breaking the circuit that allows an electric current to flow through the electric heater 60.

Also, in the electric heating device for a vehicle 110 according to the second embodiment, the temperature fuse 80 may be disposed at a mid-point in the circuit that supplies the power source to the upstream switch element drive unit 50a, which operates at a low voltage. This eliminates the necessity to dispose the temperature fuse 80 at a mid-point in a circuit that generates a high voltage and a high current. As a result, upon fusing of the temperature fuse 80, the circuit that supplies the power source to the upstream element drive unit 50a can be reliably disconnected. Therefore, the electric heating device for a vehicle 110 may be used with high reliability to protect the electric heater 60 driven with high-voltage and high-current DC power.

In the second embodiment, the temperature fuse 80 is disposed on the upstream side of the electric heater 60. However, even when disposed on the downstream side of the electric heater 60, the temperature fuse 80 may be implemented on the same device.

As disclosed herein, a short-circuit failure and an open failure in the switch element of an electric heater or in the switch element drive unit thereof may each reliably detected to allow a circuit to be broken. Upon drive of an upstream switch element, a switch element control signal may be generated in an upstream switch element control unit based on a switch element function diagnosis signal generated in a switch element function diagnosis signal generation unit and on a switch element functional abnormality detection signal output from an upstream switch element functional abnormality detection unit as a result of detecting the presence or absence of an abnormality in the upstream switch element or in an upstream switch element drive unit. From the switch element control signal and the switch element function diagnosis signal that have been generated, a new switch element drive signal may be generated to drive the upstream switch element drive unit and control the ON/OFF state of the electric heater.

Hereinabove, the embodiments of the present invention have been described in detailed with reference to the drawings. However, since the embodiments are only illustrative and exemplary of the present invention, the present invention is not intended to be limited to the configurations disclosed in the embodiments. It will be appreciated that design modifications or the like should be considered to be included in the present invention without departing from the gist of the present invention. It is to be understood that, when multiple configurations are incorporated in each of the embodiments, for example, possible combinations of these configurations are included in the present invention without any particular description. It should further be understood that, when multiple embodiments and modifications are disclosed, any possible combinations of configurations among these embodiments and modifications are considered to be included in the present invention without any particular description. Moreover, configurations disclosed in the accompanying drawings are naturally considered to be included in the present invention without any particular description. Further, the term “and/or the like (such as)” is used to indicate that any equivalent is also included. Also, when such terms as “substantially,” “about,”, and “approximately” are used, this means that values or the like within a range or accuracy which is reasonably acceptable are also included.

The priority application, Japanese Patent Application No. 2012-129544, filed Jun. 7, 2012, is incorporated by reference herein.

What is claimed is:

1. An electric heating device for a vehicle, comprising:
a switch element configured to allow an electric current to flow through an electric heater;
a switch element control unit configured to generate a switch element control signal, and a switch element drive signal for driving the switch element based on the switch element control signal; and
a switch element drive unit configured to drive the switch element with the switch element drive signal;
wherein the switch element control unit is configured to generate a new switch element control signal based on a switch element function diagnosis signal for diagnosing an abnormality in the switch element or in the switch element drive unit and based on a switch element functional abnormality detection signal obtained when the switch element is driven with the switch element drive signal, the switch element functional abnormality detection signal including an indication of a presence or an absence of the abnormality in the switch element or in the switch element drive unit, and
wherein the switch element control unit is configured to generate a new switch element drive signal based on the new switch element control signal and based on the switch element function diagnosis signal.

2. The electric heating device according to claim 1, wherein the switch element control unit is configured to generate the switch element control signal for defining an ON/OFF state of the switch element.

3. The electric heating device according to claim 1, further comprising a switch element function diagnosis signal generation unit configured to generate the switch element function diagnosis signal for diagnosing the abnormality in the switch element or in the switch element drive unit.

4. The electric heating device according to claim 1, further comprising a switch element functional abnormality detection unit configured to detect, upon drive of the switch element, the presence or the absence of the abnormality in the switch element or in the switch element drive unit.

5. The electric heating device according to claim 1, further comprising a switch element functional abnormality detection unit configured to output, as the switch element functional abnormality detection signal, any one of a signal indicating that the switch element or the switch element drive unit has incurred a short-circuit failure, a signal indicating that the switch element or the switch element drive unit has incurred an open failure, and a signal indicating that each of the switch element and the switch element drive unit is normally operating without a failure.

6. The electric heating device according to claim 1, further comprising a switch element functional abnormality detection unit configured to generate the switch element functional abnormality detection signal by performing a logical EXCLUSIVE-OR operation between (1) the switch element function diagnosis signal, and (2) one of a signal indicating that the switch element or the switch element drive unit has incurred a short-circuit failure, a signal indicating that the switch element or the switch element drive unit has incurred an open failure, or a signal indicating that each of the switch element and the switch element drive unit is normally operating without a failure.

7. The electric heating device according to claim 6, wherein the switch element control unit is configured to smooth and then invert the switch element functional abnormality detection signal such that the new switch element control signal is generated.

8. The electric heating device according to claim 7, wherein the switch element control unit is configured to perform a logical AND operation between the new switch element control signal and the switch element function diagnosis signal such that the new switch element drive signal is generated.

9. The electric heating device according to claim 1, further comprising the electric heater, wherein the electric heater is configured to generate heat upon a flow of the electric current therethrough.

10. The electric heating device according to claim 9, further comprising a temperature fuse disposed at a mid-point in a circuit configured to supply a power source to the switch element drive unit so as to come in contact with a heat generating portion of the electric heater, wherein the temperature fuse is configured to be fused in an event of abnormal heat generation from the elect c heater.

11. The electric heating device according to claim 9, wherein the switch element is a first switch element disposed on an upstream side of the electric heater, and wherein the electric heating device further comprises a second switch element disposed on a downstream side of the electric heater.

12. The electric heating device according to claim 11, wherein the switch element control unit is a first switch element control unit disposed on the upstream side of the electric heater, and wherein the electric heating device comprises a second switch element disposed on the downstream side of the electric heater.

13. The electric heating device according to claim 12, wherein the switch element drive unit is a first switch drive unit disposed on the upstream side of the electric heater, and wherein the electric heating device further comprises a second switch element drive unit disposed on the downstream side of the electric heater.

14. The electric heating device according to claim 13, further comprising a first switch element functional abnormality detection unit disposed on the upstream side of the electric heater, and a second switch element functional abnormality detection unit disposed on the downstream side of the electric heater,
wherein the first and second switch element functional abnormality detection units are configured to detect, upon drive of the switch element, the presence or the absence of the abnormality in the switch element or in the switch element drive unit.

15. The electric heating device according to claim 14, wherein, upon detection of a short-circuit failure or an open failure on either one of the upstream and downstream sides of the electric heater, both of the first and second switch elements are disconnected.

16. A method of heating a vehicle compartment in a vehicle, comprising:
generating a control signal with a control unit;
driving a switch element via a drive unit with a drive signal that is generated based on the control signal, the switch element being connected to an electric heater in an air conditioning system in the vehicle such that a flow of electric current to the electric heater is controllable;
generating a switch element function diagnosis signal for diagnosing an abnormality in the switch element or in the switch element drive unit;
detecting, upon the driving the switch element, a presence or an absence of the abnormality in the switch element or in the drive unit;
outputting a switch element functional abnormality detection signal including an indication of the presence or the absence of the abnormality in the switch element or in the switch element drive unit;
generating a new control signal with the control unit based on the switch element function diagnosis signal and based on the switch element functional abnormality detection signal obtained when the switch element is driven with the switch element drive signal; and
generating a new element drive signal based on the new control signal and based on the switch element function diagnosis signal.

17. The method according to claim 16, wherein the switch element control signal defines an ON/OFF state of the switch element.

18. The method according to claim 16, wherein the outputting of the switch element functional abnormality detection signal comprises outputting any one of a signal indicating that the switch element or the drive unit has incurred a short-circuit failure, a signal indicating that the switch element or the drive unit has incurred an open failure, and a signal indicating that each of the switch element and the drive unit is normally operating without a failure.

19. The method according to claim 16, wherein the outputting of the switch element functional abnormality detection signal comprises performing a logical EXCLUSIVE-OR operation between the switch element function diagnosis signal, and one of a signal indicating that the switch element or the drive unit has incurred a short-circuit failure, a signal indicating that the switch element or the drive unit has incurred an open failure, or a signal indicating that each of the switch element and the drive unit is normally operating without a failure.

20. The method according to claim 19, wherein the generating the new control signal comprises smoothing and then inverting the switch element functional abnormality detection signal, and wherein the generating the new control signal comprises performing a logical AND operation between the new control signal and the switch element function diagnosis signal.
